(19) United States
(12) Patent Application Publication
(10) Pub. No.: US 2010/0014726 A1
(43) Pub. Date: Jan. 21, 2010

(54) HIERARCHICAL MOTION ESTIMATION

(75) Inventors: Dirk Schaefer, Hamburg (DE); Andreas Engler, Mannheim (DE); Babak Movassaghi, Denver, CO (US); Volker Rasche, Erbach (DE); Michael Grass, Buchholz In Der Nordheide (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindoven (NL)

(21) Appl. No.: 12/302,897

(22) PCT Filed: May 21, 2007
(86) PCT No.: PCT/IB2007/051915

§ 371 Date: Dec. 1, 2008

(30) Foreign Application Priority Data
Jun. 1, 2006 (EP) 06114809.4

(51) Int. Cl. G06K 9/00; G06K 9/36

(52) U.S. Cl. 382/128; 382/236

(57) ABSTRACT

In three-dimensional rotational x-ray coronary imaging problems may arise when estimating the motion of small vessels. According to an exemplary embodiment of the present invention, an examination apparatus is provided which is adapted for performing a hierarchical motion estimation by global affine transformation for every heart phase, followed by vessel branch selective affine and non-affine transformations. This may provide for an improved image quality.

X-ray coronary angiography is an imaging technique for visualising the morphology and motion of the coronary arteries. For example, coronary arteries can be imaged with interventional x-ray systems after injection of contrast agent. Due to the slow acquisition of x-ray projections compared to computed tomography (CT), gating techniques deliver poor image quality. To achieve a motion-corrected three-dimensional or four-dimensional reconstruction, the motion vector field has to be estimated and considered in the reconstruction process.

Known methods for coronary motion estimation and reconstruction suffer from the semi-locality of the motion estimate by a 4D-B-solid-spline algorithm. Such methods are disclosed in C. Blondel et al., “4D deformation field of coronary arteries from monoplane rotational X-ray angiography”, CARS, pp. 1073-1078, 2003, and C. Blondel, R. Vaillant, G. Malandain, N. Ayache, “3D tomographic reconstruction of coronary arteries using a precomputed 4D motion field”, Phys. Med. Biol. 49, 2197-2208, 2004, which are hereby incorporated by reference.

The B-solid-warping parameters, defining a motion vector for every point in the volume to be reconstructed, are derived by optimising the response of the forward projected coronary model centreline onto the corresponding vesselness-filtered x-ray angiogram. This approach may cause artefacts like small vessels with bad filter response that are turned into the parent vessel with better response.

To prevent the occurrence of such degenerated motions an internal “bending-energy” may be added as regularisation term.

This regularisation term, however, may prevent the algorithm to track vessels if they exhibit a strong change in their bending shape and the weighting of this term may have to be chosen carefully.

It would be desirable to have an improved motion estimation for coronary imaging.

The invention provides an examination apparatus for hierarchical motion estimation of an object of interest, an image processing device, a computer-readable medium, a program element data method of hierarchical motion estimation.

It should be noted that the following described exemplary embodiments of the invention apply also for the method of hierarchical motion estimation, for the computer-readable medium, for the image processing device and for the program element.

According to an exemplary embodiment of the present invention, an examination apparatus for hierarchical motion estimation of an object of interest may be provided, the examination apparatus comprising a calculation unit, wherein the calculation unit is adapted for estimating a global affine transformation of the object of interest, estimating a first selective affine transformation of a first region of the object of interest, and estimating a selective non-affine transformation of the first region of the object of interest.

Therefore, according to this exemplary embodiment of the present invention, the examination apparatus may be adapted for performing a hierarchical motion estimation comprising several steps. The steps are hierarchical and comprise a global affine transformation, followed by a selective affine transformation and a selective non-affine transformation. This may lead to an improved image quality and may enable a quantitative three-dimensional assessment and analysis of vascular structures and anomalies.

According to another exemplary embodiment of the present invention, the above estimation steps result in a motion field, wherein the calculation unit is further adapted for applying the resulting motion field by using a voxel-driven reconstruction scheme of filtered back-projection type.

According to another exemplary embodiment of the present invention, the application of the motion field comprises the steps of correcting all voxel to be reconstructed for the global affine transformation, and correcting only voxel close to a three-dimensional transformed and forward projected centreline control point for the selective affine transformation and for the selective non-affine transformation.

This two step reconstruction may improve the image quality for vessels, which are not considered in the optimisation process when they are not covered by control points.

According to another exemplary embodiment of the present invention, the object of interest is a coronary artery tree, wherein the global affine transformation is estimated for a first heart phase and for a second heart phase, and wherein the global affine transformation is estimated for a first projection frame and for a second projection frame.

Therefore, the estimation of the global affine transformation of the coronary tree may be performed for every heart phase and then more specific for every projection frame.

According to another exemplary embodiment of the present invention, the first region of the object of interest is a first vessel branch of the coronary artery tree. Furthermore, a second selective affine transformation is estimated for a second vessel branch of the coronary artery tree.

Furthermore, according to another exemplary embodiment of the present invention, the selective affine transformations are estimated for the first projection frame and for the second projection frame, wherein a parent bifurcation point is kept as a pivotal point.

Therefore, the estimation of an affine transformation is performed for every vessel branch in every projection keeping the parent bifurcation point as the pivotal point.

According to another exemplary embodiment of the present invention, the selective non-affine transformation is estimated by shifting a control point of a spline-representation of the coronary tree.

Furthermore, the calculation unit may further be adapted for incorporating a weighted adaption to a first projection and a second projection of the same cardiac phase during optimisation of a single projection.

This may improve the three-dimensional depth estimation of the scheme.

According to another exemplary embodiment of the present invention, the examination apparatus may be configured as one of a three-dimensional computed tomography apparatus and a three-dimensional rotational x-ray apparatus.

According to another exemplary embodiment of the present invention, the examination apparatus is configured as one of the group consisting of a material testing apparatus, a medical application apparatus and a micro CT system.

A field of application of the invention may be medical imaging.

Furthermore, according to another exemplary embodiment of the present invention, a method of hierarchical motion estimation of an object of interest with an examination apparatus may be provided, the method comprising the steps of estimating a global affine transformation of the object of interest, estimating a first selective affine transformation of a first region of the object of interest, and estimating a selective non-affine transformation of the first region of the object of interest.

This may provide for an improved image quality and may enable quantitative three-dimensional assessment and analysis of vascular structures and anomalies.

According to another exemplary embodiment of the present invention, an image processing device for hierarchical motion estimation of an object of interest may be provided, the image processing device comprising a memory for storing a data set of the object of interest and a reconstruction unit adapted for carrying out the above-mentioned method steps.

According to another exemplary embodiment of the present invention, a computer-readable medium may be provided, in which a computer program for hierarchical motion estimation of an object of interest is stored which, when being executed by a processor, is adapted to carry out the above-mentioned method steps.

Furthermore, according to another exemplary embodiment of the present invention, a program element of hierarchical motion estimation may be provided, which, when being executed by a processor, is adapted to carry out the above-mentioned method steps.

The examination of the object of interest may be realised by the computer program, i.e. by software, or by using one or more special electronic optimisation circuits, i.e. in hardware, or in hybrid form, i.e. by means of software components and hardware components.

The program element according to an exemplary embodiment of the present invention may preferably be loaded into working memories of a data processor. The data processor may thus be equipped to carry out exemplary embodiments of the methods of the present invention. The computer program may be written in any suitable programming language, such as, for example, C++ and may be stored on a computer-readable medium, such as a CD-ROM. Also, the computer program may be available from a network, such as the World Wide Web, from which it may be downloaded into image processing units or processors, or any suitable computers.

It may be seen as the gist of an exemplary embodiment of the present invention that a hierarchical motion estimation comprising a global affine transformation for every heart phase, a vessel branch selective affine transformation, and a vessel branch selective non-affine transformation may be provided. This may improve the image quality particularly in the case of a strong bending of small vessels.

These and other aspects of the present invention will become apparent from and elucidated with reference to the embodiments described hereinafter.

Exemplary embodiments of the present invention will be described in the following, with reference to the following drawings.

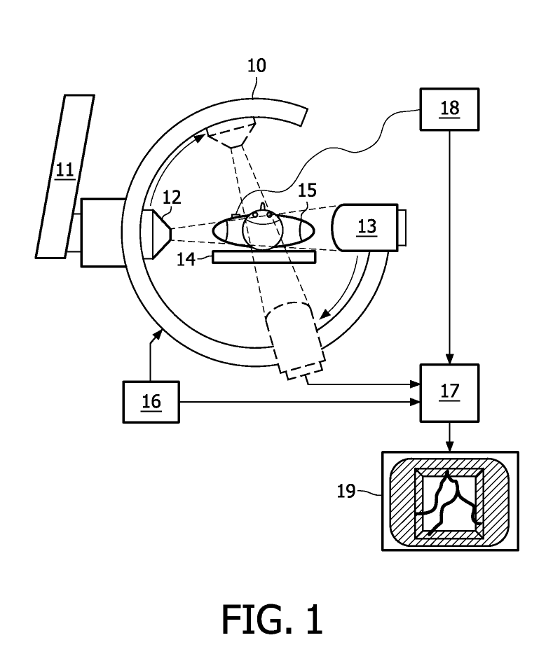

FIG. 1 shows a simplified schematic representation of an examination apparatus according to an exemplary embodiment of the present invention.

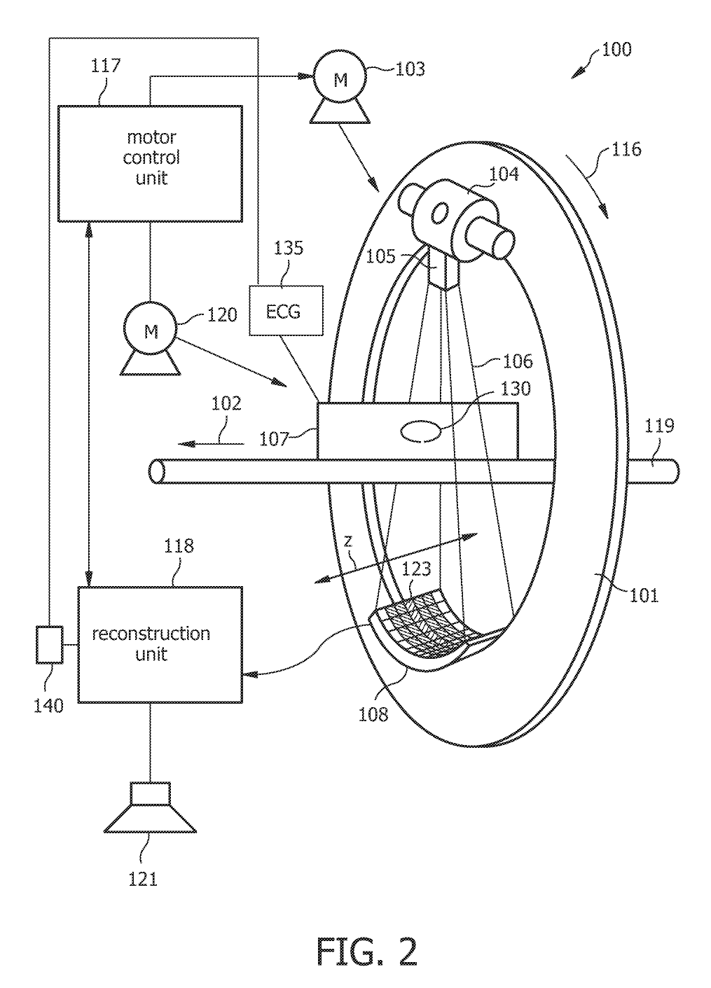

FIG. 2 shows a schematic representation of an examination apparatus according to another exemplary embodiment of the present invention.

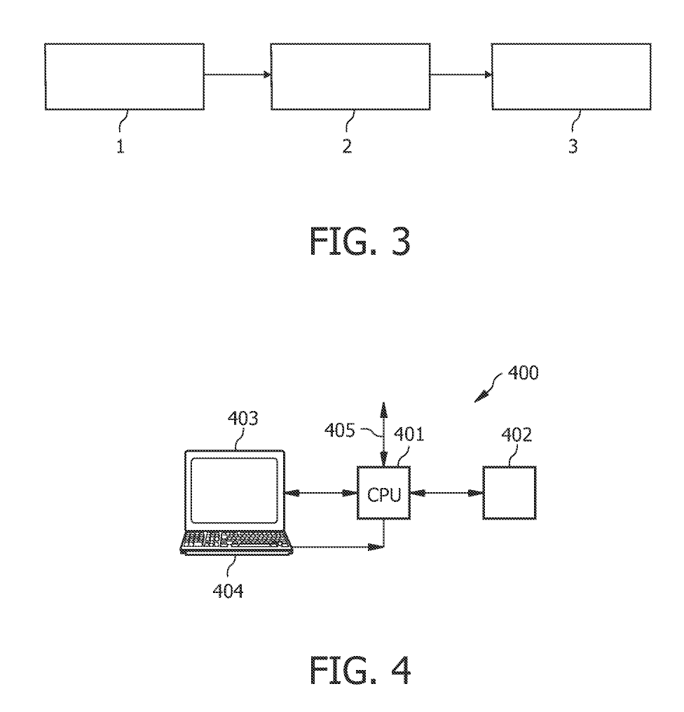

FIG. 3 shows a flow-chart of an exemplary method according to the present invention.

FIG. 4 shows an exemplary embodiment of an image processing device according to the present invention, for executing an exemplary embodiment of a method in accordance with the present invention.

### DETAILED DESCRIPTION OF EXEMPLARY EMBODIMENTS

The illustration in the drawings is schematic. In different drawings, similar or identical elements are provided with the same reference numerals.

FIG. 1 shows a simplified schematic representation of an examination apparatus according to an exemplary embodiment of the present invention.

The invention may be applied in the field of three-dimensional rotational x-ray imaging or three-dimensional rotational angiography imaging. In such a case, the examination may be performed with conventional x-ray systems.

The apparatus depicted in FIG. 1 is a C-arm x-ray examination apparatus, comprising a C-arm 10 attached to a ceiling (not depicted in FIG. 1) by means of an attachment 11. C-arm 10 holds the x-ray source 12 and detector unit 13, which may be rotatably mounted to the C-arm 10, such that a plurality of projection images of a patient 15 on table 14 can be acquired under different angles of projection.

Control unit 16 is adapted for controlling a synchronous movement of the source 12 and the detector 13, which both rotate around the patient 15.

The image data generated by the detector unit 13 is transmitted to image processing unit 17 which is controlled by a computer.

Furthermore, a ECG unit 18 may be provided for recording the heart beat of the patient's heart. The corresponding ECG data is then transmitted to the image processing unit 17.

The image processing unit 17 is adapted to carry out the method steps according to the invention.

Furthermore, the system my comprise a monitor 19 adapted for visualizing the acquired images.

The invention may also be applied in the field of computed tomography.

FIG. 2 shows an exemplary embodiment of a computed tomography scanner system according to the present invention.

The computer tomography apparatus 100 depicted in FIG. 2 is a cone-beam CT scanner. However, the invention may also be carried out with a fan-beam geometry. In order to generate a primary fan-beam, the aperture system 105 can be configured as a slit collimator. The CT scanner depicted in FIG. 2 comprises a gantry 101, which is rotatable around a rotational axis 102. The gantry 101 is driven by means of a motor 103. Reference numeral 104 designates a source of radiation such as an X-ray source, which, according to an aspect of the present invention, emits polychromatic or monochromatic radiation.

Reference numeral 105 designates an aperture system which forms the radiation beam emitted from the radiation source to a cone-shaped radiation beam 106. The cone-beam 106 is directed such that it penetrates an object of interest 107 arranged in the center of the gantry 101, i.e. in an examination region of the CT scanner, and impinges onto the detector 108. As may be taken from FIG. 2, the detector 108 is arranged on the gantry 101 opposite to the source of radiation 104, such that the surface of the detector 108 is covered by the cone beam 106. The detector 108 depicted in FIG. 2 comprises a plurality of detector elements 123 each capable of detecting X-rays which have been scattered by or passed through the object of interest 107.

During scanning the object of interest 107, the source of radiation 104, the aperture system 105 and the detector 108 are rotated along the gantry 101 in the direction indicated by an arrow 116. For rotation of the gantry 101 with the source of radiation 104, the aperture system 105 and the detector 108, the motor 103 is connected to a motor control unit 117, which is connected to a calculation unit 118 (which might also be denoted as a reconstruction or determination unit).

In FIG. 2, the object of interest 107 is a human being which is disposed on an operation table 119. During the scan of, e.g., the heart 130 of the human being 107, while the gantry 101 rotates around the human being 107, the operation table 119 displaces the human being 107 along a direction parallel to the rotational axis 102 of the gantry 101. By this, the heart 130 is scanned along a helical scan path. The operation table 119 may also be stopped during the scans to thereby measure signal slices. It should be noted that in all of the described cases it is also possible to perform a circular scan, where there is no displacement in a direction parallel to the rotational axis 102, but only the rotation of the gantry 101 around the rotational axis 102.

Moreover, an electrocardiogram device 135 may be provided which measures an electrocardiogram of the heart 130 of the human being 107 while X-rays attenuated by passing the heart 130 are detected by detector 108. The data related to the measured electrocardiogram are transmitted to the calculation unit 118.

The detector 108 is connected to the control unit 118. The reconstruction unit 118 receives the detection result, i.e. the read-outs from the detector elements 123 of the detector 108 and determines a scanning result on the basis of these read-outs. Furthermore, the calculation unit 118 communicates with the motor control unit 117 in order to coordinate the movement of the gantry 101 with motors 103 and 120 with the operation table 119.

The calculation unit 118 may be adapted for reconstructing an image from read-outs of the detector 108. A reconstructed image generated by the calculation unit 118 may be output to a display (not shown in FIG. 2) via an interface 122.

The calculation unit 118 may be realized by a data processor to process read-outs from the detector elements 123 of the detector 108.

The computer tomography apparatus shown in FIG. 2 captures multi-cycle cardiac computer tomography data of the heart 130. In other words, when the gantry 101 rotates and when the operation table 119 is shifted linearly, then a helical scan is performed by the X-ray source 104 and the detector 108 with respect to the heart 130. During this helical scan, the heart 130 may beat a plurality of times. During these beats, a plurality of cardiac computer tomography data are acquired. Simultaneously, an electrocardiogram may be measured by the electrocardiogram unit 135. After having acquired these data, the data are transferred to the calculation unit 118, and the measured data may be analyzed retrospectively.

It should be noted, however, that the CT apparatus of FIG. 2 may also perform a circular scan without linear shift of the patient table. In case of a helical scan, the shift may be so small, that a data overlap exists for two consecutive rotations of the gantry.

The measured data, namely the cardiac computer tomography data and the electrocardiogram data are processed by the calculation unit 118 which may be further controlled via a graphical user-interface (GUI) 140. This retrospective analysis is based on a helical cardiac cone beam reconstruction scheme using retrospective ECG gating. It should be noted, however, that the present invention is not limited to this specific data acquisition and reconstruction.

FIG. 3 shows a flow-chart of an exemplary method according to the present invention for performing a hierarchical motion estimation of an object of interest with an examination apparatus. A standard rotational angiography acquisition is performed while the vessels of interest are filled with contrast agent. The electrocardiogram (ECG) is measured or any other method is applied to correlate the projections to a specific cardiac phase. The initial centerline of the coronary vessels under consideration is determined from the projections of one specific heart phase using e.g. a modeling approach exploiting the epipolar constraints. The hierarchical motion estimation consists of several steps. In every step, the cost function for the optimisation comprises the sum of all grey-values of the filtered projection along the three-dimensionally transformed and forward projected centreline:

The method starts at Step 1 with the estimation of a global affine transformation of the coronary tree for every heart phase and then more specific for every projection frame.

Then, in Step 2, an estimation of an affine transformation is performed for every vessel branch in every projection keeping the parent bifurcation point as the pivotal point.

Furthermore, in Step 3, an estimation of a non-affine transformation is performed by shifting control points of the spline-representation of the coronary tree. The weighting of the bending regularisation term may be less critical, because the main part of the motion is already covered by the preceding estimation steps.

The resulting motion field may be applied in two steps using a special voxel-driven reconstruction algorithm of filtered back-projection type.

All voxel to be reconstructed may be corrected for the global affine transformation. Only voxel close to the centreline control-points may be corrected for the affine transformations of the vessel-branches and the non-affine part.

The above described two-step reconstruction may improve the image quality for vessels, which are not considered in the optimisation process when they are not covered by control points.

During the optimisation steps for a single projection, a weighted adaption to projections of the same cardiac phase may be incorporated into the procedure in order to improve the three-dimensional depth estimation of the method.

FIG. 4 depicts an exemplary embodiment of a data processing device 400 according to the present invention for executing an exemplary embodiment of a method in accordance with the present invention. The data processing device 400 depicted in FIG. 4 comprises a central processing unit (CPU) or image processor 401 connected to a memory 402 for storing an image depicting an object of interest, such as a patient or an item of baggage. The data processor 401 may be connected to a plurality of input/output network or diagnosis devices, such as a CT device. The data processor 401 may furthermore be connected to a display device 403, for example, a computer monitor, for displaying information or an image computed or adapted in the data processor 401. An operator or user may interact with the data processor 401 via a keyboard 404 and/or other output devices, which are not depicted in FIG. 4.

Furthermore, via the bus system 405, it may also be possible to connect the image processing and control processor 401 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

Applying the methods according to an exemplary embodiment of the present invention to three-dimensional/four-dimensional rotational x-ray imaging of the coronary tree may lead to improved image quality and may enable quantitative three-dimensional assessment and analysis of vascular structures and anomalies.

The invention may be used also for improved coronary modelling algorithms.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Examination apparatus for hierarchical motion estimation of an object of interest (107), the examination apparatus (100) comprising:
a calculation unit (118);
wherein the calculation unit is adapted for:
estimating a global affine transformation of the object of interest (107);
estimating a first selective affine transformation of a first region of the object of interest (107); and
estimating a selective non-affine transformation of the first region of the object of interest (107).

2. The examination apparatus of claim 1,
wherein the estimation steps result in a motion field;
wherein the calculation unit is further adapted for:
applying the resulting motion field by using a voxel-driven reconstruction scheme of filtered back-projection type.

3. The examination apparatus of claim 2,
wherein application of the motion field comprises the steps of:
correcting all voxel to be reconstructed for the global affine transformation;
correcting only voxel close to a three-dimensional transformed and forward projected centreline control point for the selective affine transformation and for the selective non-affine transformation.

4. The examination apparatus of claim 1,
wherein the object of interest (107) is a coronary artery tree;
wherein the global affine transformation is estimated for a first heart phase and for a second heart phase; and
wherein the global affine transformation is estimated for a first projection frame and for a second projection frame.

5. The examination apparatus of claim 1,
wherein the first region of the object of interest (107) is a first vessel branch of the coronary artery tree; and
wherein a second selective affine transformation is estimated for a second vessel branch of the coronary artery tree.

6. The examination apparatus of claim 5,
wherein the selective affine transformations are estimated for the first projection frame and for the second projection frame; and
wherein a parent bifurcation point is kept as a pivotal point.

7. The examination apparatus of claim 1,
wherein the selective non-affine transformation is estimated by shifting a control point of a spline-representation of the coronary tree.

8. The examination apparatus of claim 1,
wherein a cost function for a motion estimation optimisation consists of a sum of all grey-values of a filtered projection along the three-dimensional transformed and forward projected centreline.

9. The examination apparatus of claim 1,
wherein the calculation unit is further adapted for:
incorporating a weighted adaptation to a first projection and a second projection of the same cardiac phase during optimisation for a single projection.

10. The examination apparatus of claim 1, configured as one of a 3D computed tomography apparatus and a 3D rotational X-ray apparatus.

11. The examination apparatus of claim 1, configured as one of the group consisting of a material testing apparatus, a medical application apparatus and a micro CT system.

12. A method of hierarchical motion estimation of an object of interest (107) with an examination apparatus, method comprising the steps of:
estimating a global affine transformation of the object of interest (107);
estimating a first selective affine transformation of a first region of the object of interest (107); and
estimating a selective non-affine transformation of the first region of the object of interest (107).

13. An image processing device for hierarchical motion estimation of an object of interest (107), the image processing device comprising:
a memory for storing a data set of the object of interest (107);
a reconstruction unit (118) adapted for:
estimating a global affine transformation of the object of interest (107);
estimating a first selective affine transformation of a first region of the object of interest (107); and
estimating a selective non-affine transformation of the first region of the object of interest (107).

14. A computer-readable medium (402), in which a computer program of hierarchical motion estimation of an object of interest (107) is stored which, when being executed by a processor (401), is adapted to carry out the steps of:
estimating a global affine transformation of the object of interest (107);
estimating a first selective affine transformation of a first region of the object of interest (107); and
estimating a selective non-affine transformation of the first region of the object of interest (107).

15. A program element of hierarchical motion estimation of an object of interest (107), which, when being executed by a processor (401), is adapted to carry out the steps of:
estimating a global affine transformation of the object of interest (107);
estimating a first selective affine transformation of a first region of the object of interest (107); and
estimating a selective non-affine transformation of the first region of the object of interest (107).
